(19) United States
(12) Patent Application Publication
(10) Pub. No.: US 2003/0193172 A1
(43) Pub. Date: Oct. 16, 2003

(54) Triple-wheel stroller having a foldable operation device

(76) Inventor: Wang-Hsin Lin, Taichung (TW)

Correspondence Address: Wang-Hsin Lin, 58, MA YUAN WEST ST., TAICHUNG, TW

(21) Appl. No.: 10/124,701

(22) Filed: Apr. 10, 2002

(51) Int. Cl. B62B 7/06

(52) U.S. Cl. 280/642

(57) ABSTRACT

A triple-wheel stroller includes a front fork seat, two push rods each pivotally mounted on one of two upper ends of the front fork seat, and a foldable operation device. The foldable operation device is mounted between the front fork seat and each of the push rods, and includes a positioning seat, a support seat, a pivot seat, a sleeve, a pull bar, and a snap pull member. Thus, the snap pull member may be pulled upward to lift the pull bar which lifts the sleeve which may lift and move a riveting pin that passes through the sleeve to detach from the positioning seat, so that each of the push rods may be folded.

### BACKGROUND OF THE INVENTION

1. Field of the Invention

The present invention relates to a triple-wheel stroller having a foldable operation device, and more particularly to a triple-wheel stroller having a foldable operation device, wherein the triple-wheel stroller has a simple construction having fewer parts, thereby saving costs of fabrication.

2. Description of the Related Art

A conventional triple-wheel stroller has a large and bulky volume, and cannot be folded easily and conveniently, thereby causing inconvenience to the user. In addition, the volume of the conventional triple-wheel stroller cannot be reduced efficiently when it is folded, thereby causing inconvenience in use, storage and transportation.

### SUMMARY OF THE INVENTION

The present invention has arisen to mitigate and/or obviate the disadvantage of the conventional triple-wheel stroller.

The primary objective of the present invention is to provide a triple-wheel stroller having a foldable operation device, wherein the triple-wheel stroller has a simple construction having fewer parts, thereby saving costs of fabrication.

Another objective of the present invention is to provide a triple-wheel stroller having a foldable operation device, wherein the triple-wheel stroller may be operated and folded easily, rapidly and conveniently, thereby facilitating the user using the triple-wheel stroller.

A further objective of the present invention is to provide a triple-wheel stroller having a foldable operation device, wherein the triple-wheel stroller may have a small volume when being folded, thereby facilitating storage and transportation of the triple-wheel stroller.

A further objective of the present invention is to provide a triple-wheel stroller having a foldable operation device, wherein the triple-wheel stroller may have a small volume when being folded, thereby relatively reducing the volume and cost of package.

In accordance with the present invention, there is provided a triple-wheel stroller having a foldable operation device, comprising:

a front fork seat, two push rods each pivotally mounted on one of two upper ends of the front fork seat, and a foldable operation device, wherein:

the foldable operation device is mounted between the front fork seat and each of the push rods, and includes a positioning seat, a support seat, a pivot seat, a sleeve, a pull bar, and a snap pull member;

the positioning seat is secured on each of the two upper ends of the front fork seat;

the support seat is secured on each of the two upper ends of the front fork seat, and is located above the positioning seat;

the pivot seat is pivotally mounted on each of the two upper ends of the front fork seat, and is located above the support seat;

the sleeve is mounted in the lower end of each of the two push rods;

the pull bar is movably mounted in each of the two push rods; and

the snap pull member is mounted on the upper end of each of the two push rods, and wherein:

the snap pull member may be pulled upward to lift the pull bar which lifts the sleeve which may lift and move a riveting pin that passes through the sleeve to detach from the positioning seat, so that each of the push rods may be folded.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a triple-wheel stroller having a foldable operation device in accordance with a preferred embodiment of the present invention;

FIG. 2 is an exploded perspective view of the triple-wheel stroller having a foldable operation device in accordance with the preferred embodiment of the present invention;

FIG. 3 is a side plan view of the triple-wheel stroller having a foldable operation device as shown in FIG. 1;

FIG. 3A is a schematic operational view of the triple-wheel stroller having a foldable operation device as shown in FIG. 3 in use;

FIG. 4 is a schematic operational view of the triple-wheel stroller having a foldable operation device as shown in FIG. 3 in folding;

FIG. 5 is a schematic operational view of the triple-wheel stroller having a foldable operation device as shown in FIG. 4 in folding.

### DETAILED DESCRIPTION OF THE INVENTION

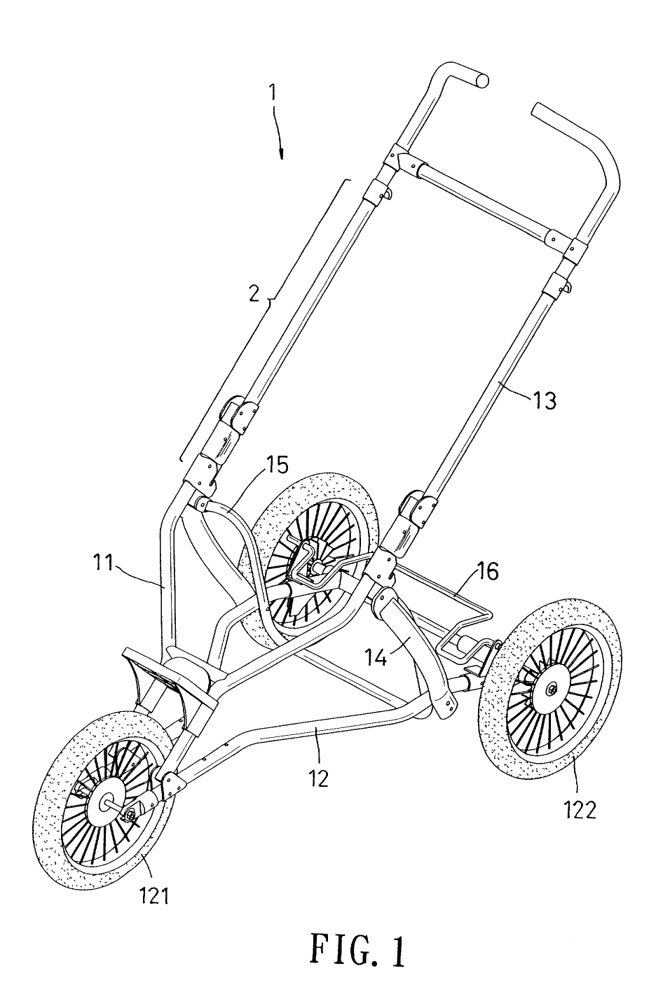

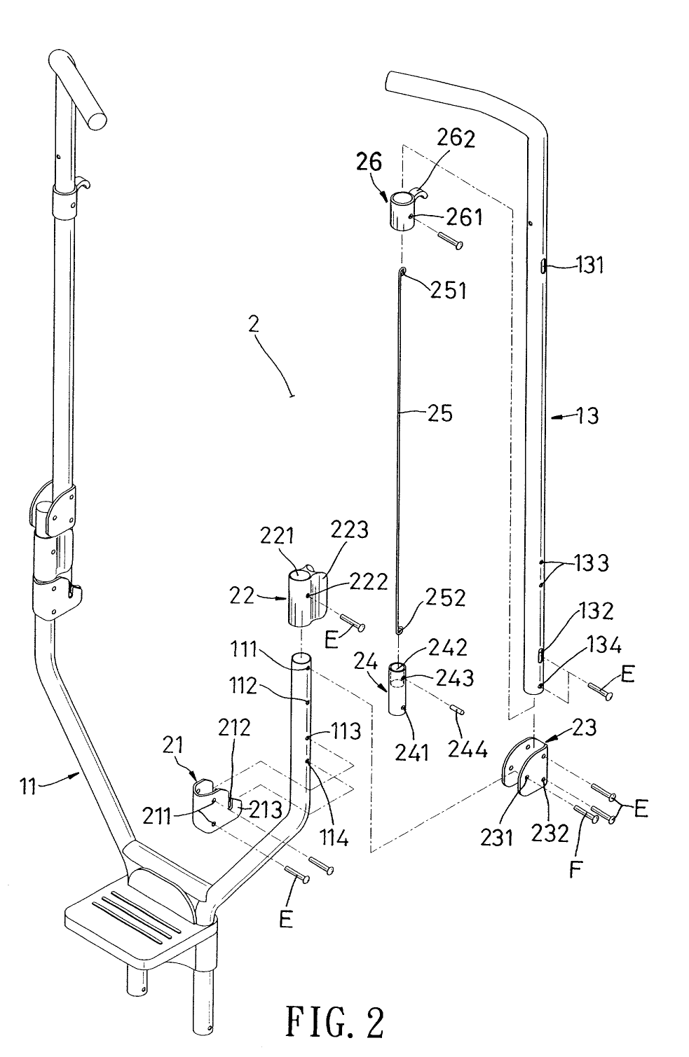

Referring to the drawings and initially to FIGS. 1-3, a triple-wheel stroller 1 having a foldable operation device 2 in accordance with a preferred embodiment of the present invention comprises a front fork seat 11, a substantially V-shaped front leg seat 12 pivotally mounted on the front fork seat 11, two push rods 13 each pivotally mounted on one of two upper ends of the front fork seat 11, a front wheel 121 rotatably mounted on a front end of the front leg seat 12, two rear wheels 122 each rotatably mounted on a rear end of the front leg seat 12, a reinforcing tube 14 pivotally mounted between the distal end of each of the push rods 13 and the rear section of the front leg seat 12, a rear leg seat 15 pivotally mounted between the distal end of each of the push rods 13 and the rear section of the front leg seat 12, and a braking rod 16 mounted between the two rear wheels 122.

The foldable operation device 2 in accordance with the preferred embodiment of the present invention is mounted between the front fork seat 11 and each of the push rods 13, and includes a positioning seat 21, a support seat 22, a pivot seat 23, a sleeve 24, a pull bar 25, and a snap pull member 26.

Each of the two upper ends of the front fork seat 11 is formed with a first through hole 111, a second through hole 112, a third through hole 113, and a fourth through hole 114.

Each of the two push rods 13 has an upper end formed with an upper oblong slot 131, and a lower end formed with a lower oblong slot 132. The lower end of each of the two push rods 13 is formed with two upper through holes 133 located above the lower oblong slot 132, and a lower through hole 134 located under the lower oblong slot 132.

The positioning seat 21 is secured on each of the two upper ends of the front fork seat 11, and is formed with two through holes 211 respectively aligning with the third through hole 113 and the fourth through hole 114 of each of the two upper ends of the front fork seat 11 for passage of two riveting pins “E”, so that the positioning seat 21 may be secured on each of the two upper ends of the front fork seat 11. The positioning seat 21 has a front portion provided with a hook portion 213 formed with a positioning recess 212.

The support seat 22 is a soft rubber seat that is secured on each of the two upper ends of the front fork seat 11, and is located above the positioning seat 21. The support seat 22 has a first side formed with a mounting chamber 221 for receiving each of the two upper ends of the front fork seat 11, and formed with a through hole 222 aligning with the second through hole 112 of each of the two upper ends of the front fork seat 11 for passage of a riveting pin “E”, so that the support seat 22 may be secured on each of the two upper ends of the front fork seat 11. The support seat 22 has a second side formed with two arcuate lips 223 for receiving each of the two push rods 13 therebetween.

The pivot seat 23 is a substantially U-shaped seat that is pivotally mounted on each of the two upper ends of the front fork seat 11, and is located above the support seat 22. The pivot seat 23 has two side walls each formed with a pivot hole 231 aligning with the first through hole 111 of each of the two upper ends of the front fork seat 11 for passage of a pivot pin “F”, so that the pivot seat 23 may be pivotally mounted on each of the two upper ends of the front fork seat 11. Each of the two side walls of the pivot seat 23 is formed with two through holes 232 respectively aligning with the two upper through holes 133 of each of the two push rods 13, for passage of two riveting pins “E”, so that each of the two push rods 13 may be secured on the pivot seat 23.

The sleeve 24 is mounted in the lower end of each of the two push rods 13, and has a lower end formed with a circular through hole 241 aligning with the lower oblong slot 132 of each of the two push rods 13 for passage of a riveting pin “E” which has two ends protruding outward from the lower oblong slot 132 of each of the two push rods 13. The sleeve 24 has an upper end formed with a receiving hole 242 which has a side wall formed with a through hole 243 for passage of a positioning pin 244.

The pull bar 25 is movably mounted in each of the two push rods 13, and has an upper end formed with a loop 251. The pull bar 25 has a lower end formed with a loop 252 received in the receiving hole 242 of the sleeve 24 and aligned with the through hole 243 of the sleeve 24 for passage of the positioning pin 244.

The snap pull member 26 is a ring-shaped mounting member that is mounted on the upper end of each of the two push rods 13. The snap pull member 26 has a side wall formed with a through hole 261 aligning with the upper oblong slot 131 of each of the two push rods 13 for passage of a riveting pin “E”. The snap pull member 26 has an upper end provided with an arcuate snap plate 262.

In assembly, referring to FIGS. 1-3, the lower end of the pull bar 25 is received in the receiving hole 242 of the sleeve 24, with the loop 252 of the pull bar 25 being aligned with the through hole 243 of the sleeve 24 for passage of the positioning pin 244, thereby securing the lower end of the pull bar 25 in the receiving hole 242 of the sleeve 24.

Then, the upper end of the pull bar 25 is inserted into each of the two push rods 13, with the loop 251 of the pull bar 25 being aligned with the upper oblong slot 131 of each of the two push rods 13.

Then, the snap pull member 26 is mounted on the upper end of each of the two push rods 13, with the through hole 261 of the snap pull member 26 being aligned with the upper oblong slot 131 of each of the two push rods 13.

Then, the riveting pin “E” is in turn extended through the through hole 261 of the snap pull member 26, the upper oblong slot 131 of each of the two push rods 13, and the loop 251 of the pull bar 25, thereby positioning the snap pull member 26 and the pull bar 25.

Thus, when the upper end of the pull bar 25 is positioned, the lower end of the pull bar 25 may be received in each of the two push rods 13, while the sleeve 24 is also received in each of the two push rods 13. At the same time, the circular through hole 241 of the sleeve 24 is aligned with the lower oblong slot 132 of each of the two push rods 13 for passage of the riveting pin “E” whose two ends being protruded outward from the sides of the lower oblong slot 132 of each of the two push rods 13.

Then, the positioning seat 21 is mounted on each of the two upper ends of the front fork seat 11, with the two through holes 211 of the positioning seat 21 being respectively aligned with the third through hole 113 and the fourth through hole 114 of each of the two upper ends of the front fork seat 11 for passage of the two riveting pins “E”, so that the positioning seat 21 may be secured on each of the two upper ends of the front fork seat 11.

Then, the support seat 22 is mounted on each of the two upper ends of the front fork seat 11, and is located above the positioning seat 21. At this time, the through hole 222 of the support seat 22 is aligned with the second through hole 112 of each of the two upper ends of the front fork seat 11 for passage of the riveting pin “E”, so that the support seat 22 may be secured on each of the two upper ends of the front fork seat 11.

Then, the pivot seat 23 is mounted on each of the two upper ends of the front fork seat 11, and is located above the support seat 22. At this time, the pivot hole 231 of the pivot seat 23 is aligned with the first through hole 111 of each of the two upper ends of the front fork seat 11 for passage of the pivot pin “F”, so that the pivot seat 23 may be pivotally mounted on each of the two upper ends of the front fork seat 11.

Then, each of the two push rods 13 is inserted into the pivot seat 23, with the two upper through holes 133 of each of the two push rods 13 being respectively aligned with the two through holes 232 of the pivot seat 23, for passage of the two riveting pins “E”, so that each of the two push rods 13 may be secured on the pivot seat 23.

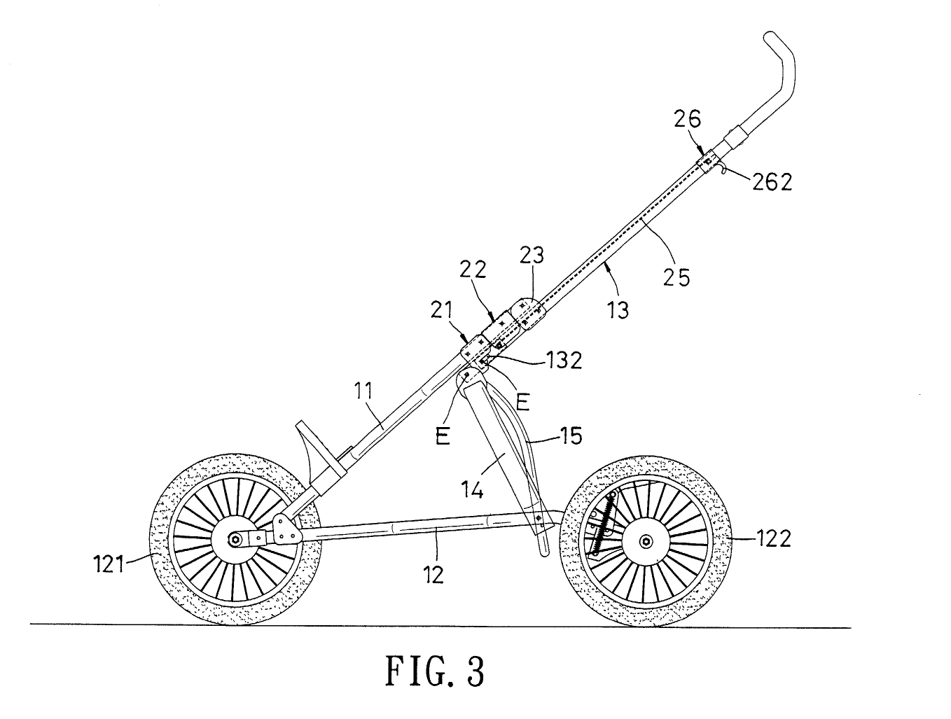

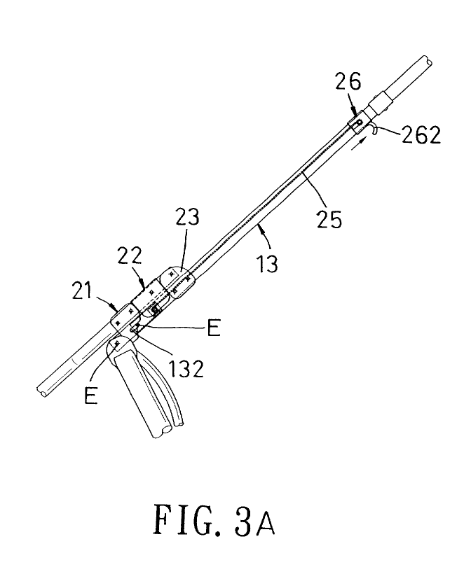

Then, the lower through hole 134 of each of the two push rods 13 allows passage of a riveting pin “E”, so that each of the push rods 13 may be secured with the reinforcing tube 14 and the rear leg seat 15 as shown in FIG. 3.

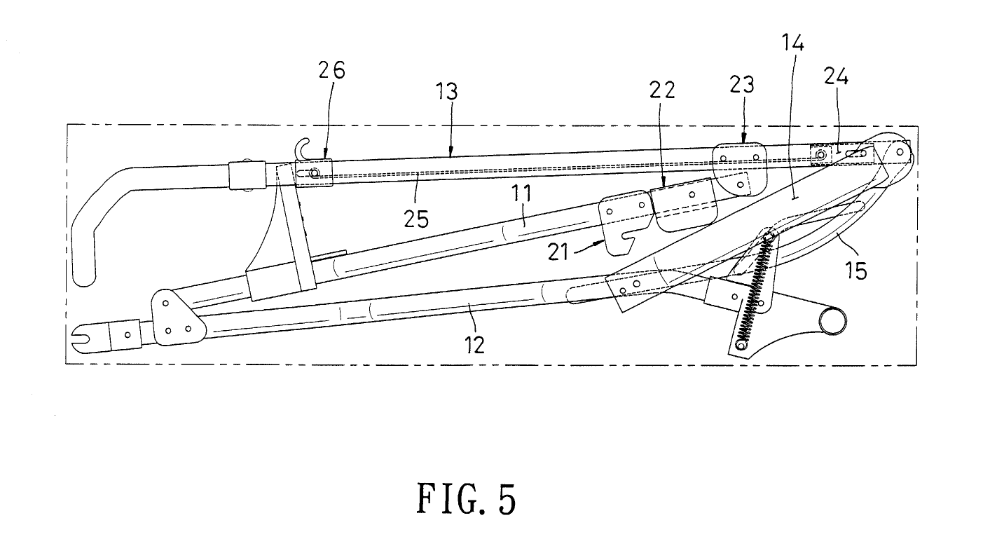

In operation, referring to FIGS. 3A, 4 and 5 with reference to FIGS. 1-3, when the triple-wheel stroller 1 having a foldable operation device 2 in accordance with the preferred embodiment of the present invention is disposed at a normally extended usage state, the protruding two ends of the riveting pin “E” that passes through the lower oblong slot 132 of each of the two push rods 13 and the circular through hole 241 of the sleeve 24 are inserted into the positioning recess 212 of the hook portion 213 of the positioning seat 21 as shown in FIG. 3. Thus, each of the two push rods 13 is secured on the front fork seat 11, so that the entire skeleton of the entire triple-wheel stroller 1 may be supported and fixed, thereby facilitating the user pushing each of the two push rods 13 to move the triple-wheel stroller 1.

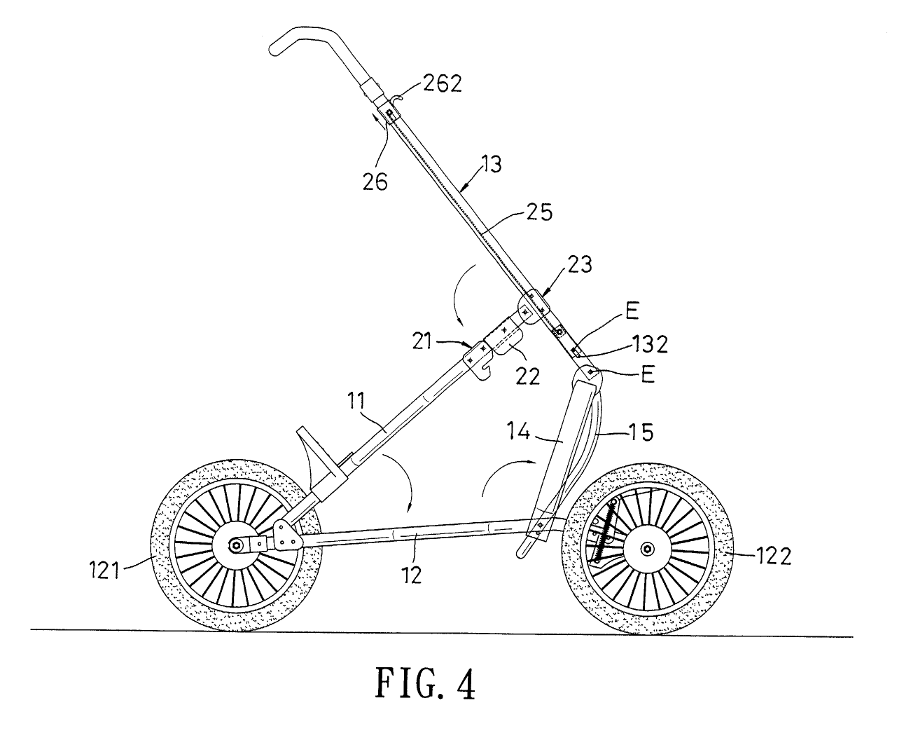

When the user wishes to fold the entire triple-wheel stroller 1, the snap plate 262 of the snap pull member 26 may be pulled upward by the user's hand, to lift the pull bar 25 which lifts the sleeve 24 which may lift and move the riveting pin “E” that passes through the circular through hole 241 of the sleeve 24 to the top of the lower oblong slot 132 of each of the two push rods 13 as shown in FIG. 3A, so that the riveting pin “E” may detach from the positioning recess 212 of the hook portion 213 of the positioning seat 21 as shown in FIG. 3A. Thus, each of the two push rods 13 may be pivoted about the pivot seat 23 to move toward the front fork seat 11 as shown in FIG. 4. Then, each of the two push rods 13 may be continuously pressed downward to drive the front fork seat 11 to move toward the front leg seat 12. On the other hand, the reinforcing tube 14 and the rear leg seat 15 are driven by each of the two push rods 13 to move rearward to be almost in line with the front leg seat 12, until each of the two push rods 13, the front fork seat 11, the front leg seat 12, the reinforcing tube 14 and the rear leg seat 15 are almost in parallel with each other, thereby folding the triple-wheel stroller 1.

Accordingly, the triple-wheel stroller having a foldable operation device in accordance with the preferred embodiment of the present invention has the following advantages.

1. The triple-wheel stroller has a simple construction having fewer parts, thereby saving costs of fabrication.

2. The triple-wheel stroller may be operated and folded easily, rapidly and conveniently, thereby facilitating the user using the triple-wheel stroller.

3. The triple-wheel stroller may have a small volume when being folded, thereby facilitating storage and transportation of the triple-wheel stroller.

4. The triple-wheel stroller may have a small volume when being folded, thereby relatively reducing the volume and cost of package.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A triple-wheel stroller having a foldable operation device, comprising:
a front fork seat, two push rods each pivotally mounted on one of two upper ends of the front fork seat, and a foldable operation device, wherein:
the foldable operation device is mounted between the front fork seat and each of the push rods, and includes a positioning seat, a support seat, a pivot seat, a sleeve, a pull bar, and a snap pull member;
the positioning seat is secured on each of the two upper ends of the front fork seat;
the support seat is secured on each of the two upper ends of the front fork seat, and is located above the positioning seat;
the pivot seat is pivotally mounted on each of the two upper ends of the front fork seat, and is located above the support seat;
the sleeve is mounted in the lower end of each of the two push rods;
the pull bar is movably mounted in each of the two push rods; and
the snap pull member is mounted on the upper end of each of the two push rods, and wherein:
the snap pull member may be pulled upward to lift the pull bar which lifts the sleeve which may lift and move a riveting pin that passes through the sleeve to detach from the positioning seat, so that each of the push rods may be folded.

2. The triple-wheel stroller having a foldable operation device in accordance with claim 1, wherein each of the two push rods has an upper end formed with an upper oblong slot, and a lower end formed with a lower oblong slot, the lower end of each of the two push rods is formed with two upper through holes located above the lower oblong slot, and a lower through hole located under the lower oblong slot;
the positioning seat is formed with two through holes respectively aligning with the third through hole and the fourth through hole of each of the two upper ends of the front fork seat for passage of two riveting pins, so that the positioning seat may be secured on each of the two upper ends of the front fork seat;
the support seat has a first side formed with a through hole aligning with the second through hole of each of the two upper ends of the front fork seat for passage of a riveting pin, so that the support seat may be secured on each of the two upper ends of the front fork seat;
the pivot seat has two side walls each formed with a pivot hole aligning with the first through hole of each of the two upper ends of the front fork seat for passage of a pivot pin, so that the pivot seat may be pivotally mounted on each of the two upper ends of the front fork seat;
the sleeve has a lower end formed with a circular through hole aligning with the lower oblong slot of each of the two push rods for passage of a riveting pin which has two ends protruding outward from the lower oblong slot of each of the two push rods, the sleeve has an upper end formed with a receiving hole which has a side wall formed with a through hole for passage of a positioning pin;
the pull bar has a lower end formed with a loop received in the receiving hole of the sleeve and aligned with the through hole of the sleeve for passage of the positioning pin; and
the snap pull member has a side wall formed with a through hole aligning with the upper oblong slot of each of the two push rods for passage of a riveting pin.

3. The triple-wheel stroller having a foldable operation device in accordance with claim 2, wherein the positioning seat has a front portion provided with a hook portion formed with a positioning recess.

4. The triple-wheel stroller having a foldable operation device in accordance with claim 2, wherein the first side of the support seat is formed with a mounting chamber for receiving each of the two upper ends of the front fork seat.

5. The triple-wheel stroller having a foldable operation device in accordance with claim 2, wherein the support seat has a second side formed with two arcuate lips for receiving each of the two push rods therebetween.

6. The triple-wheel stroller having a foldable operation device in accordance with claim 2, wherein the each of the two side walls of the pivot seat is formed with two through holes respectively aligning with the two upper through holes of each of the two push rods, for passage of two riveting pins, so that each of the two push rods may be secured on the pivot seat.

7. The triple-wheel stroller having a foldable operation device in accordance with claim 2, wherein the pull bar has an upper end formed with a loop.

8. The triple-wheel stroller having a foldable operation device in accordance with claim 2, wherein the snap pull member has an upper end provided with an arcuate snap plate.
